(19) United States
(12) Patent Application Publication
(10) Pub. No.: US 2004/0028204 A1
(43) Pub. Date: Feb. 12, 2004

(54) Call completion to busy subscribers despite of call forwarding

(76) Inventor: Michael David Stanmore Crook, Monmouthshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/333,533

(22) PCT Filed: Jul. 20, 2001
(86) PCT No.: PCT/GB01/03276

(30) Foreign Application Priority Data
Jul. 21, 2000 (GB) 00180497

(51) Int. Cl. H04M 3/42

(52) U.S. Cl. 379/211.01; 379/211.02

(57) ABSTRACT

A method of processing a telephone call using a terminating switch node connected to a processing node, said method comprising the steps of: receiving a call from a calling party via an originating switch node and determining if a called party is available; if said called party is unavailable, passing said call to said processing node; said processing node sending a remote request for said call completion service; and said terminating switch node transmitting said remote request to said originating switch node.

This invention relates to apparatus and methods for processing a telephone call. More particularly, but not exclusively it relates to methods and systems to carry out call completion if a called party is unavailable.

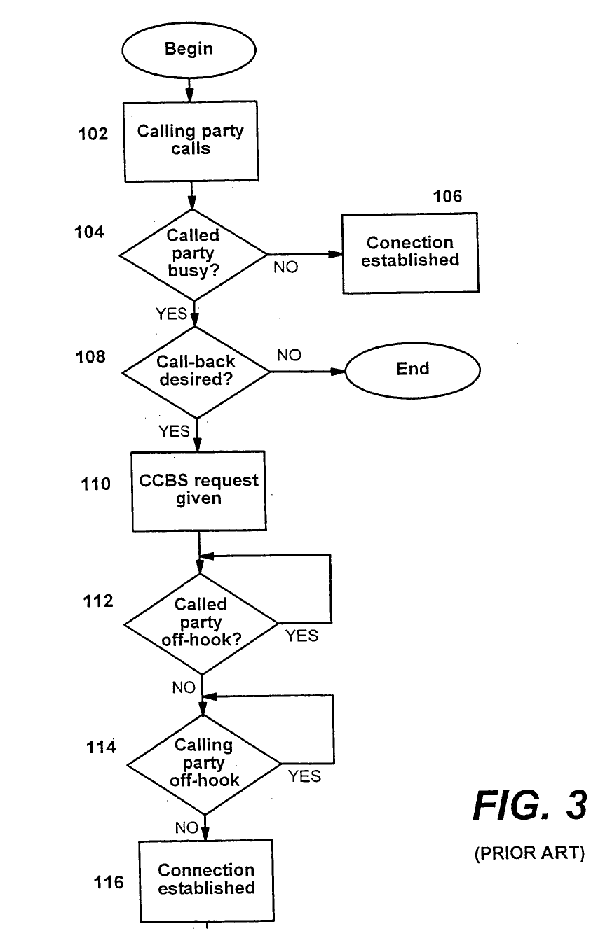

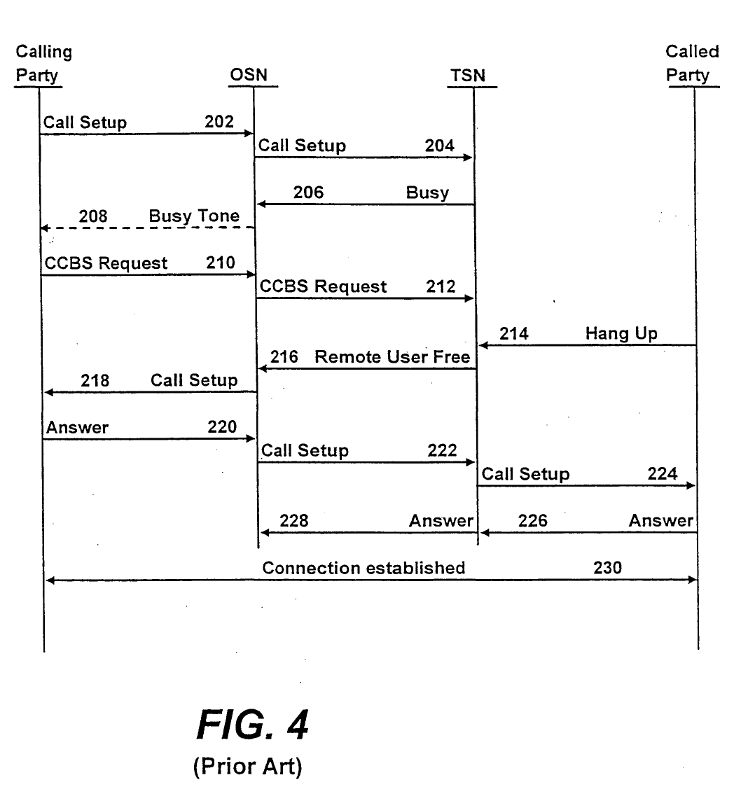

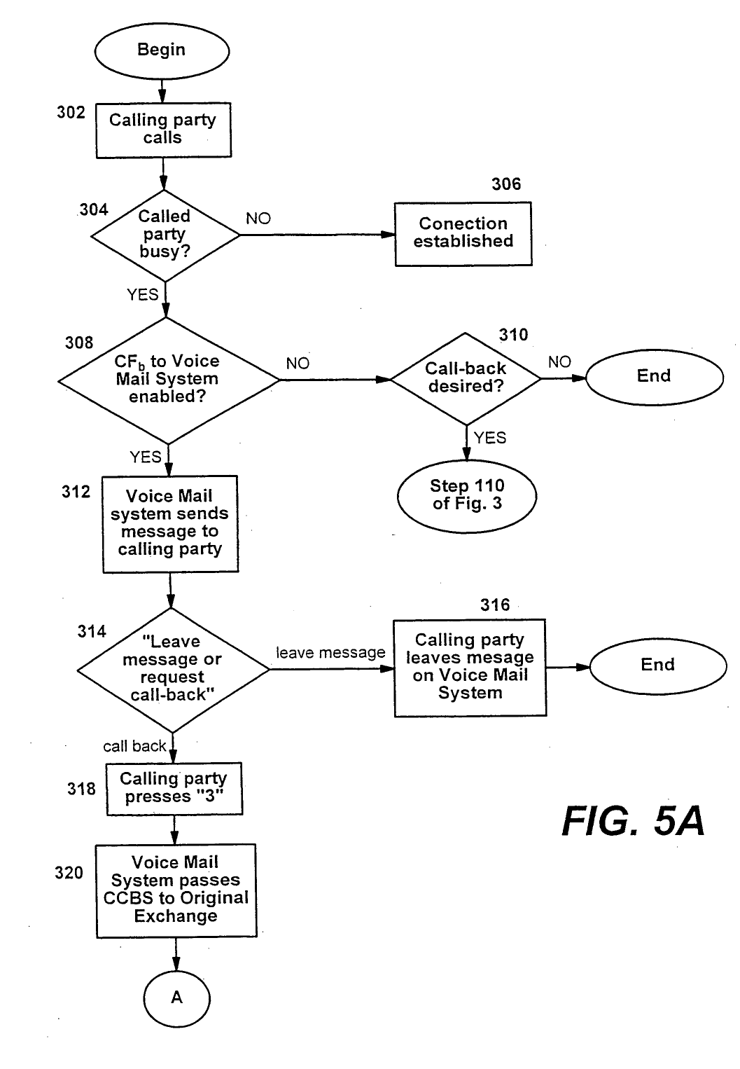

A system of call completion to busy subscriber (CCBS), which connect a calling party's telephone station to a called party's station when the called party becomes free after the called party's telephone station was busy, is known in the art. FIG. 3 is a flowchart diagram of such a system and FIG. 4 shows the different signalling messages transmitted between the different elements in such a system.

A telecommunications system capable of carrying out CCBS services includes a calling party's telephone station connected to an originating switch node (OSN). The OSN is either directly, or via a network of intermediate switch nodes, connected to a terminating switch node (TSN). The called party's telephone station is connected to the TSN 14. Referring to FIGS. 3 and 4, a calling party calls a called party's telephone station in step 102. To place a call, the request for call setup is passed from the calling party to an OSN (step 202) and further to a TSN (step 204). If the called party's station is busy, a message signalling that the called party's telephone set is busy is transmitted from the TSN to the OSN in step 206. The calling party is subsequently provided by the OSN a tone signalling that the called party's station is busy in step 208.

If the called party's telephone station is busy, the calling party has the possibility of requesting the CCBS service in step 108. The CCBS request is for example given by operating the calling party's telephone touch-tone keypad and a predetermined DTMF signal is transmitted from the calling party to the OSN in step 210. The OSN then signals to the TSN that CCBS is requested in step 212. The TSN then determines if the called party's telephone station is in an off-hook state in step 112. If the telephone station is off-hook, the TSN waits until the called party has hung up the receiver in step 214. A message is then transmitted from the TSN to the OSN that the called party is free in step 216. The OSN then places a first call leg to the calling party in step 218. If this call is answered (step 220), the OSN places a second call leg to the called party via the TSN in steps 222 and 224. If this second call is answered (step 226), a message is transmitted from the TSN to the OSN (step 228) and a connection between the calling and the called party's telephone station is established by bridging the first and second call legs.

The CCBS request as commonly available can only be sent when the OSN has been informed that the called party is busy. If the call is answered by a voice mail system, the OSN is not informed that the called party is busy. Hence, CCBS cannot be requested.

U.S. Pat. No. 5,668,853 describes a method and system for providing a call progress option for a calling party whose telephone call has been connected via a switching facility to a central voice feature apparatus. A telephone switching facility is connected in combination to a voice feature service apparatus and to the telephone sets of the calling party and the called party. If the call is being forwarded to the voice feature service apparatus, the calling party may signal a request for call progressing to the voice feature service apparatus. The voice feature service apparatus may then carry out the call progressing or pass a message for initiating call progressing to the switching facility. Subsequently, when both parties are detected as being on-hook, the calling party is signalled with a ring back signal. Although it is mentioned that a network of exchanges may be involved, no way of implementing the system across a network of exchanges is described. A number of drawbacks are apparent. For example, if the call progressing is controlled by the voice mail system or is passed to the switching exchange connected in to the voice feature system, this may have charging implications. In the call progress service, only the originally called party can be charged for the calls establishing the connection between the calling and the called party, unless both parties are connected to the same exchange or at least the same network operator.

Japanese patent application number JP-A-8293920 describes a voice mail system with a call back function. If a calling party's telephone call cannot be completed, for example because the called party's telephone station is busy, the calling party may leave a message for the called party. This message is sent from the calling party via an originating switch node (OSN) to a terminating switch node (TSN). The OSN retrieves the calling party's telephone number from a subscriber database and transmits the number to the TSN. The TSN stores the received message together with the calling party's telephone number in an audio storage device. The message is played back to the called party when the called party's telephone station becomes free. If the called party wishes to arrange for a real time conversation with the calling party after hearing this message or while still listening to the message, the called party requests call completion by inputting a key sequence into the telephone station's keypad. Then the TSN reads the calling party's number from the memory and connects to the calling party's terminal via the OSN to establish real time conversation between the calling party and the called party. Thus, the callback is not under the control of the calling party.

It is an object of the present invention to overcome the disadvantages described above and allow a CCBS service even if call forwarding on busy subscriber to, or via, a processing node is enabled.

According to one aspect of the present invention, there is provided a method of processing a telephone call using a terminating switch node connected to a processing node, said method comprising the steps of: receiving a call from a calling party via an originating switch node and determining if a called party is available; if said called party is unavailable, passing said call to said processing node; said processing node sending a remote request for said call completion service; and transmitting said remote request to said originating switch node.

In this way a call completion service may be provided even if the called party is unavailable and the call has been passed to a processing node. The request for call completion is passed sent from the processing node via the TSN to the OSN. In this way control of the call completion service is kept on the side of the calling party.

Call completion service may thus be provided although the call is set up to the processing node, and the calling party may be charged for the calls and the service, even though the call is initially answered by the processing node.

Preferably the method of processing a telephone call comprises the step of said processing node providing said calling party with an option to request call completion service in addition to, or instead of, a different service provided by said processing node.

In this way the calling party has the option to either choose a service provided by the processing node or to choose the call completion service instead.

In a first embodiment, the processing node includes a voice mail system or a paging bureau and the method comprises: if said called party is unavailable, determining if call forwarding to said voice mail system or paging bureau is enabled for said called party; and setting up said call to said voice mail system or paging bureau if call forwarding is enabled; and said processing node providing said called party with an option to request call completion service or message deposit for said called party.

In a second embodiment the processing node includes a call forwarding system and the method comprises the steps of: if said called party is unavailable, determining if call forwarding to a third party is enabled for said called party; setting up said call to said processing node if call forwarding to said third party is enabled; and said processing node providing said calling party with an option to request call completion service or call forwarding to said third party.

In this way the optional call completion service may be extended and is additionally provided if the call is otherwise to be forwarded to a third party.

Preferably said processing node is adapted to detect different reasons for said called party's station being unavailable and said processing node provides call completion service only for one or more, not all, of said different reasons for said called party's station being unavailable.

In this way the described service may be offered only in response to call forwarding in certain circumstances, whereas no such service is provided in other circumstances.

According to another aspect of the present invention, there is provided a method of processing a telephone call from a calling party to a called party in an originating switch node, said method comprising the steps of: receiving a remote request for call completion from a processing node via a terminating switch node; requesting said terminating switch node for call completion processing and carrying out said call completion service.

In this way an OSN receiving a remote request may then request call completion using a conventional CCBS request. The calling party may be charged for the call (and may be charged for the service), and the service may be carried out under the control of the OSN.

According to another aspect of the present invention, there is provided a telephone system, comprising: an originating switch node, having means for initiating a request for call completion; a terminating switch node, having means for receiving a signalled remote request for call completion and means for signalling said remote request to said originating switch node; telephone stations connected to said originating and terminating switch node; a processing node, connected to said terminating switch node and having means for signalling remote requests for call completion to said terminating switch.

A telephone system capable of carrying out a remote request for call completion is thus provided.

According to another aspect of the present invention, there is provided a method of processing a telephone call which is directed to a processing node because a called party's telephone station is not available, said method comprising: said processing node signalling to an originating switch node connected to the calling party's telephone station that call completion is requested; and said originating switch node requesting and carrying out said call completion service.

The processing node signals to an originating switch node that call completion is requested and the originating switch node carries out the call completion service. The calling party may be correctly charged for the set up of the call which still allows a real-time conversation to be conveniently set up between the calling and the called party.

Further aspects and advantages of the invention will be appreciated from the following description and accompanying drawings, wherein:

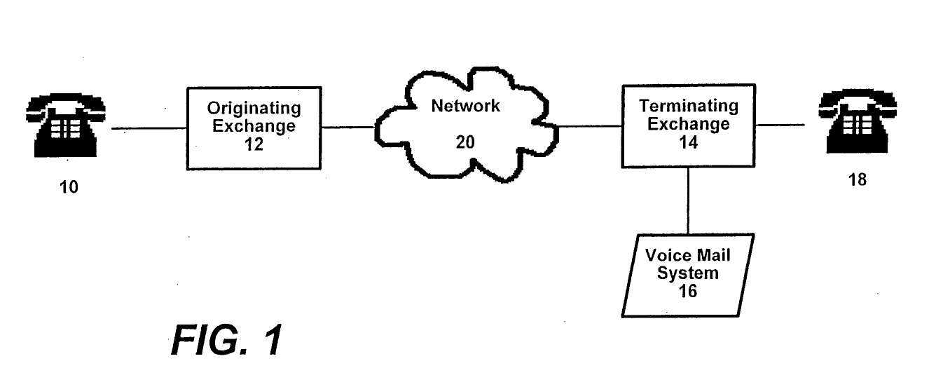

FIG. 1 is a general outline of a fixed line network according to the prior art and in which the present invention may be implemented;

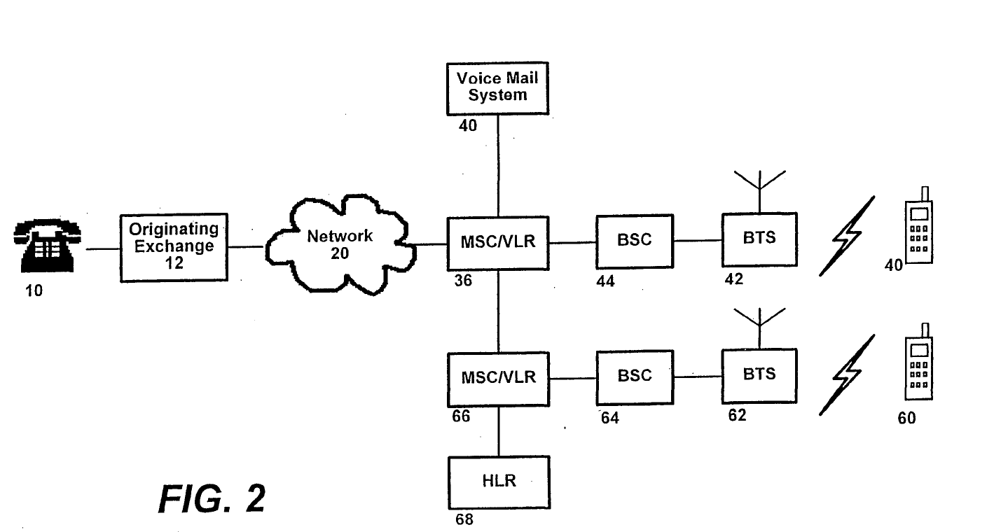

FIG. 2 is a schematic diagram of the general outline of a fixed-line network combined with a mobile communications network according to the prior art and in which the present invention may be implemented;

FIG. 3 is a flowchart diagram showing the steps of a call completion service according to the prior art;

FIG. 4 is a diagram showing communications between the telephone stations and switch nodes in a call completion service according to the prior art;

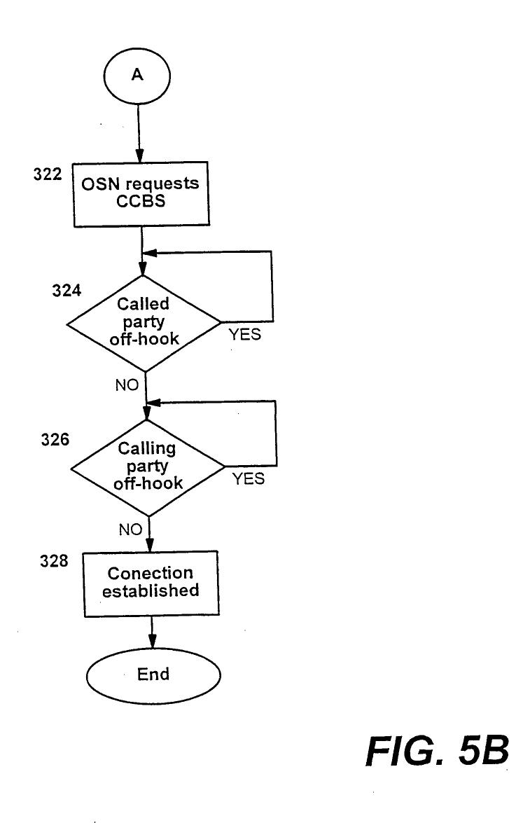

FIG. 5 is a flowchart diagram showing the steps of a call completion service according to one embodiment of the present invention;

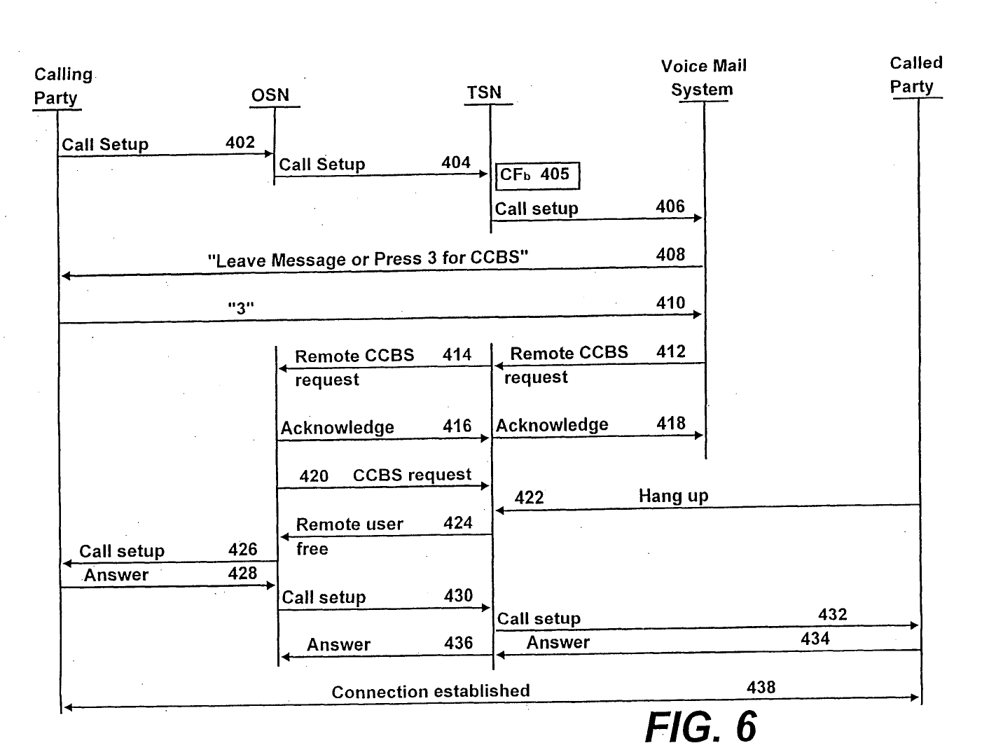

FIG. 6 is a diagram showing communications between the telephone stations, switch nodes and processing node in a call completion service according to one embodiment of the present invention.

FIG. 1 is a schematic diagram showing elements involved in the handling of a call made by a first fixed-line telephone, of the calling party, to a second fixed-line telephone, of the called party, when the called party has an active voice mail service provided in the network.

The first telephone station 10 is connected to a first switching node, the originating exchange 12. This originating exchange 12 may be directly connected to a terminating exchange 14. More generally, the originating exchange 12 is connected via a network of intermediate switch nodes (20) to a terminating exchange 14, as shown in FIG. 1. The terminating exchange 14 is connected to the second telephone station 18. In this way a telephone conversation can be established for example from the first telephone station 10 of a calling party to a second telephone station 18 of a called party. If now for example the called party's telephone station is busy when the telephone call is set up, the terminating exchange may forward the call to a voice mail processing node 16. In this way the calling party may leave a message for the called party if a real-time conversation is not possible.

FIG. 2 is a schematic diagram showing elements involved in the handling of a call made by a fixed-line telephone of the calling party, to a mobile telecommunications station of the called party as used in state of the art telecommunications systems. The mobile telecommunications network of the called party is provided with a voice mail processing node.

If a calling party would like to establish a telecommunications connection from a fixed-line telephone station 10 to a mobile station 40 of the called party, a number of intermediate stations are involved as outlined in FIG. 2. The fixed-line telephone station 10 of the calling party is connected via the originating exchange 12 and a network of intermediate switch nodes 20 to a mobile switching centre (MSC) 36 of a mobile communications system.

The MSC 36 is connected via communication links to a number of base station controllers (BSCs) 44. The BSCs are dispersed geographically across areas served by the mobile switching centre 36. Each BSC 44 controls one or more base transceiver stations (BTSs) 42 located remote from, and connected by further communication links to, the BSC 44. A BTS 42 transmits radio signals to, and receives signals from a mobile stations 40, which are in an area served by (BTSs) 42. The area is referred to as a “cell”. A GSM network is provided with a large number of such cells, which are ideally contiguous to provided continuous coverage over the whole network territory.

The mobile switching centre 36 is also connected via communication links to other mobile switching centres 66 in the remainder of the mobile communications system, which includes other networks, in particular GSM networks (having configurations similar to that illustrated) in other territories having roaming agreements with the illustrated network. The mobile switching centre 36 is provided with a home location register (HLR) 38 which is a database storing subscriber data. Each mobile switching centre is also provided with a visitor location register (VLR), which is a database temporarily storing subscriber data for mobile stations active in the area served by the mobile switching centre. In the example of FIG. 2, the VLRs are directly incorporated in the according MSCs 36, 66. The MSC/VLR is further connected to a voice mail processing node 40.

Alternatively, a connection between a first mobile station 60 of the calling party and a called party's mobile station 40 may be established in the network outlined in FIG. 2.

The connection between the elements of the telecommunications network, beyond the radio links between the mobile stations 40, 60 and the BTSs 42, 62 in mobile telecommunications networks and the links between fixed-line telephone stations 10, 18 and the directly connected exchanges 12, 14 in a fixed-line telecommunications system include traffic links and signalling links. The traffic links carry circuit connection data and the signalling links carry out-of-band signalling data. The traffic links and signalling links are on logically separate channels which are often carried on the same physical connection (for example, an optical fibre link).

Call completion service according to the state of the art, and embodiments of the invention, is performed on the basis of an out-of-band signalling system. Signalling may for example be according to the ISUP protocol SS7 (CCITT Signalling System No. 7). Basic ISUP call control is performed by messages sent from one network node in out-of-band signalling links rather than in-band traffic channels to another.

When a call is placed the originating switching node OSN transmits an ISUP initial address message (IAM) to reserve an idle circuit from the originating node to the terminating switching node TSN. The TSN examines the dialled number, determine that it serves the called party, and that the line is available. The TSN transmits an ISUP address complete message (ACM) to the OSN to indicate that the remote end of the circuit has been reserved.

If the OSN and TSN are not directly connected, the OSN transmits an IAM to reserve a circuit to an intermediate switching node ISN. The ISN transmits an IAM to reserve a circuit to another node and sends an ACM to the OSN once it receives an ACM from the other node. This process is used to reserve all circuits required to complete the circuit from the OSN to the TSN.

When a called party answers a call placed by a calling party, the TSN transmits an ISUP answer message (ANM) to the OSN. If the calling party hangs up first, the OSN sends an ISUP release message (REL) to release the circuit between the nodes. ISUP call progress message (CPGs) may also be transmitted during the circuit connection part of the call (i.e., between the ANM and REL message).

In the same way messages are signalled between the OSN and the TSN in order to carry out call completion according to the state of the art: Referring to FIG. 4, a message signalling that the called party's telephone station is busy is transmitted for example from the TSN to the OSN (step 206 of FIG. 4), the CCBS request is signalled from the OSN to the TSN in step 212 and the message that the remote user is free is signalled from the TSN to the OSN in step 216.

The present invention may be carried out by the elements outlined in FIGS. 1 and 2. At least the voice mail processing node and the originating switch node OSN are adapted, by means of a stored signalling control program, in comparison with prior art systems, to carry out the different embodiments of the present invention as will be described in the following.

In a first embodiment of the present invention the CCBS service is provided from a processing node in a fixed line telecommunications network. In this case the OSN and the TSN are equivalent to the Originating Exchange 12 and the Terminating Exchange 14, respectively, as shown in FIG. 1.

In a second embodiment of the present invention the CCBS service is provided from a processing node in a mobile communications system. The functions of the OSN and/or the TSN are carried out by the serving MSC/VLR of the calling party and/or the called party, as shown in FIG. 2. In this case the serving MSC/VLR of the called party detects that the called party is busy and accordingly forwards the call to the voice mail processing node.

Reference is now made to FIGS. 5A, 5B and 6. The first steps of placing a call from a calling party to a called party (step 304) and establishing the connection if the called party is not busy in step 306 are the same as explained above with reference to FIG. 3. The call is set up from the calling party's telephone station via the OSN to the TSN. At the TSN it is determined if the call forwarding on busy subscriber (CF_{b}) to a voice mail processing node is enabled (step 308). If CF_{b} is not enabled, the calling party receives an engages signalling tone and normal may request call completion in step 310. This will then be handled as explained above and shown in FIGS. 3 and 4. If CF_{b} to a voice mail processing node is enabled (step 405), the call is set up to the voice mail processing node in step 406 and a circuit connection between the calling party's telephone station and the voice mail processing node is established. The voice mail processing node then transmits an automated voice message, such as “leave a message or press 3 to request call completion service”, to the calling party.

This provides the calling party with the option either to make use of the voice mail system or to request a call-back service to arrange for a real-time conversation with the called party. If the calling party chooses to leave a message with the voice mail system in step 316, the call is completed. If the calling party chooses to request call-back, he or she enters a predetermined number or code, in this example “3”, on the touch-tone keypad of the telephone station (or alternatively by other methods, such as speaking a predetermined response) in step 318. With the touch-tone method, a dual-tone multi frequency (DTMF) signal is then transmitted from the calling party's telephone station to the voice mail processing node (410). Upon reception of the appropriate DTMF signal, the voice mail processing node sends a remote CCBS request via the TSN to the OSN in steps 412, 414 and 320. The remote CCBS request is transmitted via signalling links carrying out-of-band signalling data such as to the SS7 protocol (a new “remote CCBS request” message can be defined in order to extend the protocol) from the voice mail processing node via the TSN to the OSN. The OSN passes a remote CCBS acknowledgement message (also a new message to be define) via the TSN to the voice mail system to acknowledge receipt of the remote CCBS request in step 416 and 418. The OSN then initiates (step 420, and 322) and carries out a CCBS request in step 420, as in the prior art described above. Because the CCBS request is transmitted by the OSN a charge may be applied for the CCBS request, and may be made to the calling party, as in the prior art conventional CCBS service.

As soon as the called party's telephone set is detected by the TSN to be in an on-hook state again, the TSN signals to the OSN that the called party is free in step 424. The OSN then carries out the call completion service. The remaining steps of setting up a first call to the calling party (step 426) and a second call to the called party via the TSN (step 430 and 432) and establishing the connection (step 438 and 328) by bridging the first and second call are the same as described above referring to FIG. 4.

In mobile telecommunications systems there may be a number of different reasons for a called party to be unavailable: the called party's station may be busy, unreachable (if the station is switched-off) or the call is not answered. The TSN detects the reason for the station to be unavailable and transmits a signal indicating the reason to the voice mail system when forwarding the call to this system. In one embodiment of the present invention the voice mail system then distinguishes between the different reasons for the called party's station being unavailable and provides the calling party with the option for call completion service only if the called party's telephone stations is busy. If the station is switched-off or the call is not answered no such option is provided to the calling party, in order to avoid excessive unknown delays in the call completion service.

In another embodiment call completion service is provided if the called party's telephone station is busy or switched-off. If call completion service to an unreachable subscriber is requested the TSN notifies when the called party's telephone goes on-hook after being used the first time following the remote CCBS request and signals the information to the OSN. The OSN subsequently controls the call completion process as described above.

Whilst in the above described embodiments the call is forwarded to a voice mail processing node, it is appreciated that the call may alternatively be forwarded to a third party via a processing node or another service may be offered by a processing node. In this case of a call being forwarded to a third party, the TSN sets up the call to a call forwarding processing node. The call forwarding processing node is provided with voice processing means and notifies the calling party by a voice message that call forwarding to a third party is enabled and gives the option either to proceed with the call forwarding to the third party or to choose call completion service. In case the calling party chooses the call to be forwarded, the call forwarding system sets up the call to the third party. In case the calling party chooses call completion service, the call forwarding system signals the request to the OSN and the process continues as described before. Again, the option of call completion is preferably only provided for call forwarding on busy in the case of a mobile communications system.

Alternatively, the call may be forwarded to a paging bureau instead to a voice mail processing node. In this case a voice connection is established between the calling party and an agent of the paging bureau. The agent may provide the calling party with the option to choose either call completion service or to submit a paging message to the called party. If the calling party selects call completion service, the circuit connection between the paging agent and the calling party is terminated, and the paging bureau signals a remote CCBS request to the OSN.

Whilst in the above described embodiments the call is set up from the calling party to the voice mail system after the called party is found to be unavailable and a circuit connection is established between the calling party and the voice mail system in which the calling party may request call completion service, it is to be appreciated that the call may be handled by intelligent network (IN) processing at the TSN. The called party may for example have a preconfigured request for call completion. In such a case the call is forwarded to an IN processing node if the called party is unavailable. A voice message is transmitted to the calling party informing that the called party has a preconfigured call completion request and that the CCBS will be initiated. The process node or box then signals the remote CCBS request via the TSN to the OSN.

It is to be understood that the embodiments described above are preferred embodiments only. Namely, various features may be omitted, modified or substituted by equivalents without departing from the scope of the present invention, which is defined in the accompanying claims.

1. A method of processing a telephone call using a terminating switch node connected to a processing node, said method comprising the steps of:
receiving a call from a calling party via an originating switch node and determining if a called party is available;
if said called party is unavailable, passing said call to said processing node;
said processing node sending a remote request for said call completion service; and
transmitting said remote request to said originating switch node.

2. A method of processing a telephone call according to claim 1, wherein said processing node receives a request for call completion from said calling party.

3. A method of processing a telephone call according to claim 2, further comprising the step of said processing node providing said calling party with an option to request call completion service in addition to, or instead of, a different service provided by said processing node.

4. A method of processing a telephone call according to claim 1, 2 or 3, wherein said processing node includes a voice mail system or a paging bureau and the method comprises:
if said called party is unavailable, determining if call forwarding to said voice mail system or paging bureau is enabled for said called party; and
setting up said call to said voice mail system or paging bureau if call forwarding is enabled; and
said processing node providing said called party with an option to request call completion service or message deposit for said called party.

5. A method of processing a telephone call according to claim 1, 2 or 3, wherein said processing node includes a call forwarding system and the method comprises the steps of:
if said called party is unavailable, determining if call forwarding to a third party is enabled for said called party;
setting up said call to said processing node if call forwarding to said third party is enabled; and
said processing node providing said calling party with an option to request call completion service or call forwarding to said third party.

6. A method of processing a telephone call according to claim 1, wherein said processing node is an intelligent network processing node capable of initiating the call completion service on behalf of the called party.

7. A method of processing a telephone call according to any preceding claim, further comprising the step of:
said terminating switch node receiving a request for call completion service from said originating switch node and said terminating switch node assisting said originating switch node in carrying out said call completion service.

8. A method of processing a telephone call according to claim 7, said assisting comprising the steps of
determining if said called party is available;
notifying said originating switch node if said called party is available.

9. A method of processing a telephone call according to any preceding claim, wherein said processing node is adapted to detect different reasons for said called party's station being unavailable and said processing node provides call completion service only for one or more, not all, of said different reasons for said called party's station being unavailable.

10. A method of processing a telephone call according to any preceding claim, wherein said remote request is transmitted via signalling links carrying out-of-band signalling data from said processing node via said terminating switch node to said originating switch node.

11. A method of processing a telephone call from a calling party to a called party in an originating switch node, said method comprising the steps of:
receiving a remote request for call completion from a processing node via a terminating switch node;
requesting said terminating switch node for call completion processing; and
carrying out said call completion service.

12. A method of processing a telephone call according to claim 11, whereby carrying out said call completion service comprises the steps of;
setting up a first call to said calling party;
setting up a second call to said called party;
bridging said first and said second call if said first and second calls are answered.

13. A method of processing a telephone call according to claim 11 or 12, said request and said remote request for call completion are transmitted via signalling links carrying out-of-band signalling data.

14. A telephone system, comprising:
an originating switch node, having means for initiating a request for call completion;
a terminating switch node, having means for receiving a signalled remote request for call completion and means for signalling said remote request to said originating switch node;
telephone stations connected to said originating and terminating switch node;
a processing node, connected to said terminating switch node and having means for signalling remote requests for call completion to said originating switch node.

15. A method of processing a telephone call which is directed to a processing node because a called party's telephone station is not available, said method comprising:
said processing node signalling to an originating switch node connected to the calling party's telephone station that call completion is requested; and
said originating switch node requesting and carrying out said call completion service.
